(19) United States
(12) Patent Application Publication
(10) Pub. No.: US 2014/0295932 A1
(43) Pub. Date: Oct. 2, 2014

(54) Methods to Conduct Enhanced Second Chance Games via a Quorum and Prize Structure

(71) Applicant: Scientific Games International, Inc., Newark, DE (US)

(72) Inventor: Kenneth Earl Irwin, JR., Dawsonville, SC (US)

(73) Assignee: Scientific Games International, Inc., Newark, DE (US)

(21) Appl. No.: 14/226,874

(22) Filed: Mar. 27, 2014

Related U.S. Application Data
(60) Provisional application No. 61/806,466, filed on Mar. 29, 2013.

(51) Int. Cl. G07F 17/32

(52) U.S. Cl. CPC G07F 17/329
USPC 463/17

(57) ABSTRACT

A method for conducting a lottery second chance game program defines a quorum condition for entry into a second chance games, wherein a plurality of losing game tickets in a primary lottery game are needed to satisfy the quorum conditions. A quorum value is assigned to the game tickets and is linked to a unique identifier on each game ticket. Game ticket data is received from entries by players of losing game tickets, including the unique identifiers. The quorum value for the entered losing game tickets is applied to the quorum conditions for the second chance games. A prize value is established for each of the second chance games that appears to the player as a rolling prize that varies over time but is a fixed amount predetermined by one of the losing game tickets used to satisfy the quorum condition for the respective second chance game.

### RELATED APPLICATION

The present application claims priority to U.S. Provisional Application Ser. No. 61/806,466, filed on Mar. 29, 2013, the entire disclosure of which is incorporated herein by reference in its entirety for all purposes.

### FIELD OF THE INVENTION

The present invention relates to games, such as lottery games, wherein players are provided the opportunity to participate in a second chance game or event upon satisfaction of certain conditional requirements.

### BACKGROUND

Lottery games have become a time honored method of raising revenue for state and federal governments the world over. Traditional scratch-off and draw games have evolved over decades, supplying increasing revenue year after year. However, after decades of growth, the sales curves associated with traditional games seem to be flattening out. Consequently, both lotteries and their service providers are presently searching for new methods of increasing sales.

In one attempt to increase sales, United States lotteries have adopted second chance games where the consumer can enter losing lottery ticket codes on lottery Internet sites to play instant second chance games or to enter second chance drawings. However, for the most part, second chance games usually involve prizes of a minor nature compared to the main lottery games. Thus by their nature, second chance drawings are a minor part of overall game designs, are not a principal motivator for ticket purchases, and although they have their place, second chance games have limited potential for assisting in the mainstream of lottery sales via the Internet or otherwise.

In some cases, these second chance games are used to satisfy technical requirements involving the top tier prize availability in instant ticket games of limited size and duration with a set number of top prizes that may be awarded before the game is sold out. However, in these special cases, the second chance drawings only affect a very small percentage of the player base and therefore still have little impact in overall player perception or entertainment value.

Thus, it is highly desirable to develop an enhanced lottery second chance gaming platform that provides methods of funding new gaming opportunities for a broad player base with substantial prize offerings, particularly in an Internet based game environment. Ideally, this second chance gaming platform should have minimal impact on existing lottery distribution and sales venues or at least have minimal apparent impact from the consumer and retailer perspective.

### SUMMARY OF THE INVENTION

Objects and advantages of the invention will be set forth in part in the following description, or may be obvious from the description, or may be learned through practice of the invention.

At the heart of this present invention is the discovery that the consumer, as a requirement to entry into a second chance game, can be obliged to accumulate a multiplicity of non-winning tickets to form a quorum. Thus, by requiring a quorum of tickets for game entry, a method of funding second chance games with higher potential payouts and more entertainment value becomes feasible. In some embodiments, predetermined second chance prizes are linked to a subset of lottery tickets that would appear to be non-winning from a consumer's perspective, but the predetermined prizes may or may not be redeemed depending on the consumers actions. In another embodiments, no prizes would be predetermined (i.e., linked to any given ticket), rather the totality of tickets entered into the system would finance a rolling jackpot where the winner would be determined via a drawing or game play.

In accordance with aspects of the invention, a computer-implemented method for use in a lottery second chance game program includes issuing a game tickets from a terminal to players for use in a primary lottery game play, the game tickets having a unique identifier thereon. With a computer-based system, defining a quorum condition for entry into each of a plurality of second chance games, wherein a plurality of losing game tickets in the primary lottery game are needed to satisfy the quorum condition for each of the second chance games. A quorum value is assigned to the game tickets issued to players in the primary lottery game, the quorum value linked to the unique identifier of each game ticket. Game ticket data is received from entries by players of losing game tickets held by the player, including the unique identifier assigned to the respective losing game tickets. The quorum value for the entered losing game tickets is applied to the quorum conditions for the second chance games. A prize value is established for each of the second chance games that appears to the player as a rolling prize that varies over time but is a fixed amount predetermined by one of the losing game tickets used to satisfy the quorum condition for the respective second chance game. Upon satisfaction of the quorum condition for one of the second chance games, an initial game event is conducted, such as a drawing that the player must win prior to being awarded the predetermined prize amount.

The present invention also encompasses various second chance game embodiments as enabled and described herein.

Described are a number of mechanisms that provide practical details for conducting second chance games with enhanced prize and entertainment value. Although the examples provided herein are primarily related to lottery tickets, it is clear that the same methods are applicable to any type of contest, coupon, or loyalty program.

### BRIEF DESCRIPTION OF THE DRAWINGS

FIG. 1 depicts a schematic line drawing illustrating conceptual aspects of a system for implementing embodiment of the present invention;

FIG. 2 provides a block diagram of an exemplary controller according that may be used in a computer system for implementing embodiments of the present invention;

FIG. 3 is a front plan view of a first representative example of an instant lottery ticket for a second chance drawing showing the scratch-off coatings removed;

FIG. 4 is a front plan view of a first representative example of a draw game lottery ticket for a second chance drawing;

FIG. 5 is a front plan view of a first representative example of a web site display illustrating various quorums required to be completed for a second chance drawing;

FIG. 6 is a flow chart illustrating a first method of consumer registering the lottery tickets of FIGS. 2 and 3 in a quorum;

FIG. 7 is a flow chart illustrating a first method of conducting second chance drawings for the registered lottery tickets of FIG. 6 via the web site displays of FIG. 5, FIG. 8, and FIG. 9;

FIG. 8 is a front plan view of a first representative example of a web site display illustrating a second game to net up a quorum rolling jackpot to a predetermined prize amount;

FIG. 9 is a front plan view of a first representative example of FIG. 6 with the outcome of the second game illustrated increasing the quorum rolling jackpot up to a predetermined prize amount;

FIG. 10 is a front plan view of a first representative example of a game to be played prior to entry into a grand prize rolling jackpot, with multiple entries into the jackpot drawing offered in lieu of a jackpot multiplier;

FIG. 11 is a front plan view of a first representative example of a game to be played prior to entry into a grand prize rolling jackpot with a jackpot multiplier;

FIG. 12 is a front plan view of a first representative example of a game to be played prior to entry into a grand prize rolling jackpot with a jackpot multiplier with no multiplier awarded; and

FIG. 13 is a front plan view of a first representative example of a local jurisdiction low-tier instant prize award prior to or instead of entry into a grand prize rolling jackpot.

### DETAILED DESCRIPTION

Reference will now be made in detail to embodiments of the inventive methods and systems, one or more examples of which are illustrated in the drawings. Each embodiment is presented by way of explanation of the invention, and not as a limitation of the invention. For example, features illustrated or described as part of one embodiment may be used with another embodiment to yield still a further embodiment. It is intended that the present invention include these and other modifications and variations as come within the scope and spirit of the invention.

Embodiments of the methods disclosed herein may be executed by one or more suitable lottery gaming systems. Such system(s) may comprise one or more computing devices adapted to perform one or more embodiments of the methods disclosed herein. As noted above, such gaming systems and computing devices may access one or more computer-readable media that embody computer-readable instructions which, when executed by at least one computer, cause the computer(s) to implement one or more embodiments of the methods of the present subject matter. Additionally or alternatively, the computing device(s) may comprise circuitry that renders the device(s) operative to implement one or more of the methods of the present subject matter. Furthermore, components of the presently-disclosed technology may be implemented using one or more computer-readable media.

Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like.

The present disclosure also makes reference to the relay of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network may comprise any number and/or combination of hard-wired, wireless, or other communication links.

In general, the present disclosure is directed to systems and methods for conducting a lottery game that implements a second chance game program. As discussed more fully herein, the system may include a terminal for providing a game ticket to a player for use in a primary lottery game play. This terminal may be configured to distribute on-line draw game tickets or instant scratch-off tickets. The game ticket has a unique serial number or validation number assigned thereto, which is used by a player to enter the ticket into the second chance reward program.

The system includes a player interface configured to permit a player to enter game ticket data into the lottery gaming system. The system further includes a controller configured to determine whether the game ticket is a valid ticket for entry into the second chance game program and, if so, to conduct the other functionalities associated with the second chance game as described in greater detail below.

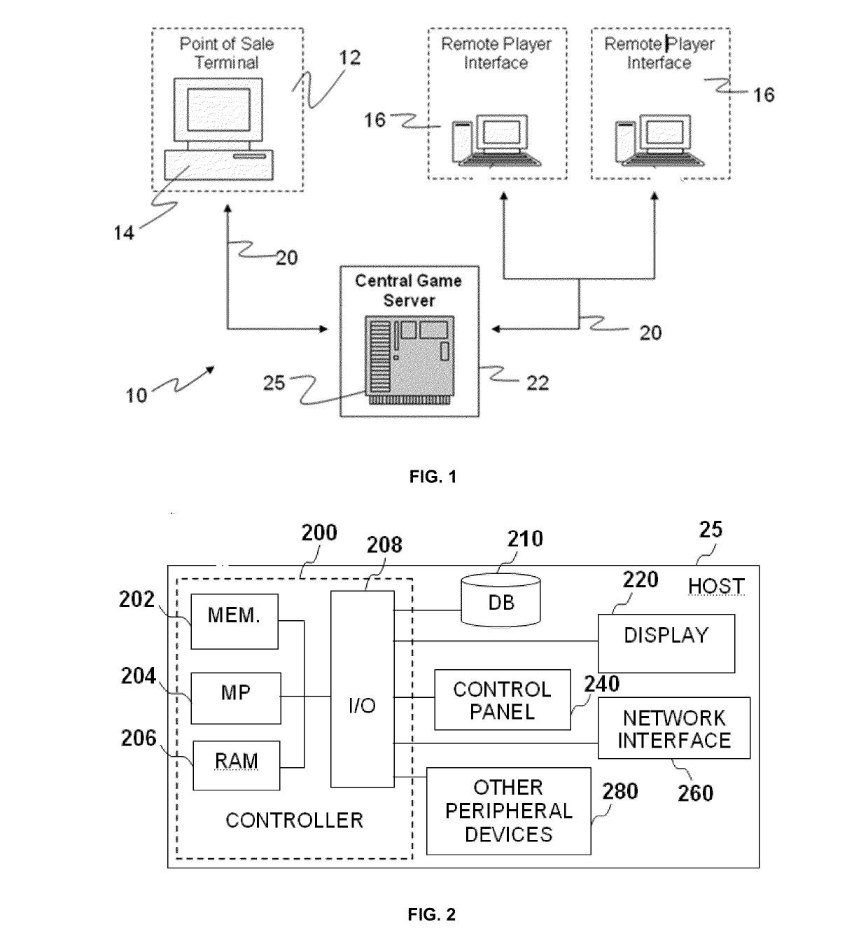

FIG. 1 depicts a schematic line drawing illustrating conceptual aspects of a computer implemented system 10 that may be used to implement various method embodiments of the present invention. The system 10 includes a point of sale location 12 where game tickets are sold to players of a primary lottery game, such as tickets for an online draw game or instant scratch-off tickets. Point of sale location 12 includes one or more terminals 14 for selling and issuing game tickets 14. FIG. 1 illustrates a single terminal 14. However, it should be readily appreciated that the system 10 may include a vast number of terminal units 14 operatively coupled to a lottery network.

The lottery network may, in turn, be in communication with the central gaming authority 22, and particularly with the central game server 25 via any suitable communications network 20. For example, in a particular embodiment, the lottery network may include a state lottery system operating within an individual state or region of states, wherein the lottery terminal units 14 are interconnected to the state lottery gaming authority.

The terminals 14 may include any conventional feature known to those skilled in the art related to lottery terminals. The terminal 14 includes features and functionality to allow a player or retail clerk to enter the information required to participate in the lottery game. An exemplary terminal 14 includes a housing, one or more input devices, which may be a control panel having input keys, a display, a value input device such as a card reader, a play slip or ticket reader, and a ticket printer. The play slip reader is typically configured to read user selection marks, bar codes, magnetically stored information, or any other desired input information. Control panel input keys allow the player or retail clerk to select the game to be played, input the value to be wagered, manually enter selected lottery characters, and input any other information necessary to play the lottery game. The terminal may include a display which may be an LCD, a CRT, or touch-screen capable of receiving and displaying information related to the game. The value input device may include any device that can accept value or a wager from a customer, such as a card reader or an optical currency collector. The value input device may be integrated with external devices, such as a cash register or other retail terminals, to exchange information necessary to receive and record the wagering transaction. The game ticket printer may be used to print or otherwise encode game tickets with information selected or required to play the lottery game. The printer may provide game tickets that reflect a player's selection, or complete lottery slips if the selection was generated automatically by the terminal. It should be readily appreciated that particular embodiments of terminals 14 are not meant as a limitation of the invention, and that embodiments of the present invention may encompass any configuration of features and functionality to allow initiation and playing of a lottery game.

The central game server 25 may be a single networked computer, or a series of interconnected computers having access to the lottery system 10 or network via any suitable networking system. Generally, the central game server 25 is configured to manage, execute, and control the individual lottery terminals 14 and the routines used to play various lottery games. As shown in more detail in FIG. 2, the central game server 25 may include a controller 200 having a memory 202 for storing lottery programs and routines, a microprocessor 204 for executing stored routines, random access memory (RAM) 206, and an input/output (I/O) bus 208.

In addition, the central game server 25 may be in communication with any manner of external device, including external or internal databases 210. Such databases 210 may provide a data repository for the storage and correlation of information gathered from the individual lottery terminals 14 relating to the individual terminals, such as terminal specific information like the machine ID, sales establishment, location, and ticket-specific information. The databases may also include a quorum database for storing information related to various quorum qualifications for second chance games or drawings, as discussed below, as well as individual player profiles that track a player's quorum tally and other aspects of the second chance game, such as results of various second chance drawings, and the like. As illustrated, controller 200 may additionally be interfaced with external components such as a display 220, a control panel 240, a network interface device 260 and other peripheral devices 280. Examples of other peripherals device include, but are not limited to, storage devices, wireless adaptors, printers, and other components. The central game server 25 may be in communication with an external Internet game server, or the functionality of an Internet game server may be incorporated into the central game server 25.

Referring back to FIG. 1, the system 10 includes a plurality of remote player interfaces 16 operatively connected to the lottery system. Remote player interface 16 may be any device that allows players to interact with the system 10. For instance, the player interface 16 can be a personal computer, desktop computer, notebook computer, personal digital assistant (PDA), WebTV (or other Internet only terminal), cell phone, screen phone, lottery terminal, or other known communication device. The player interface 16 is configured to execute one or more computer programs, such as an Internet browser program, to allow users to interact with the system 100. Player interface 16 preferably includes a visual display. The visual display may be a monitor or screen operatively connected to the system 10. Alternatively, the visual display may be incorporated into a web-browser configured to display multimedia content. For instance, a player may access the system 10 remotely via an Internet web-browser on player interface 16. A player may interact with the system 10 and view various aspects of the rewards program through the web-browser of player interface 16. For instance, a player may enter game ticket information or data into the system through player interface 16. In addition, a player may track the number of redemption points awarded to the player through player interface 16. The player interface 16 may also be used to affect an exchange of redemption points for merchandise, prizes, gift certificates, travel packages, or entries into additional lottery games.

In one embodiment, the player interface 16 is located at a point of sale location 12, and may even be a part of the terminal 14. In this embodiment, a player may interact with the system 10 while purchasing or receiving a game ticket. The system 10 may aid the player in making purchase decisions for particular lottery games. For example, a player may view the number of quorum points/value needed for entry into the second chance game options and may then make a purchase decision at the terminal based on this information.

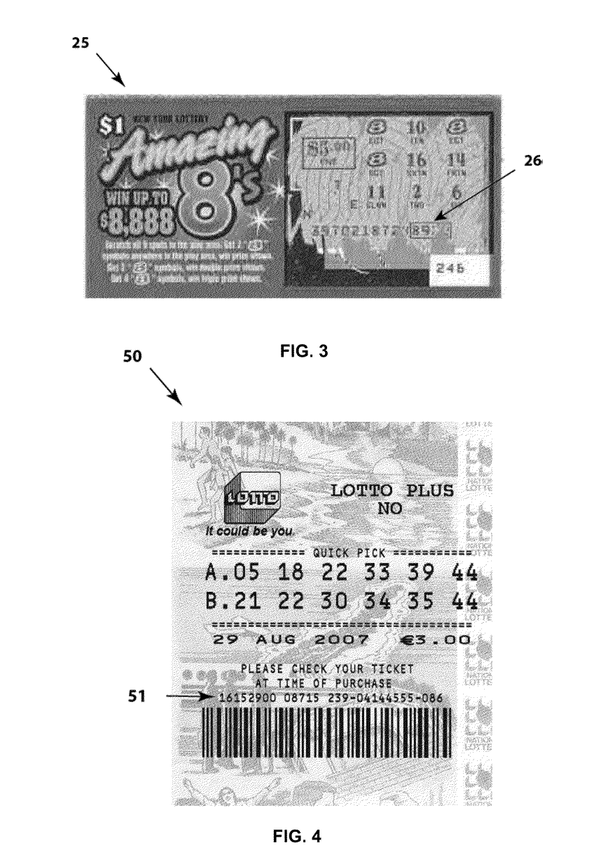

As their name implies, second chance drawings (or other types of second chance games or events) are a method for a consumer to win a prize with an apparent losing ticket from an initial game, such as a losing instant or draw lottery ticket. Traditionally, these second chance tickets can be from losing instant (scratch-off) game tickets 25 of FIG. 3, or losing draw game tickets 50 of FIG. 4, or a combination of the two types. Typically, the consumer enters a unique serial or validation number from the printed indicia available on the purchased ticket (i.e., 26 in FIGS. 3 and 51 in FIG. 4) on a web site or other method (e.g., mobile, mail-in drawing, etc.) to enter the second chance drawing.

The prizes for these second chance drawings are generally funded from a portion of the sales of the lottery tickets. For example, in a typical instant ticket game of, the prize fund (i.e., the percentage of the purchase price of the ticket that is devoted to prizes) is usually around 65%, with the remaining 35% funding the lottery as well as the production, distribution, validation, and other logistical functions associated with the instant ticket game. In a typical draw game, the prize fund is usually around 50%, with the remainder again being devoted to lottery profit and the logistics of creating the draw game itself. Thus, the funds reserved for the second chance drawing typically either come from the winning prize fund or the remainder. Funding the second chance drawing from the prize fund has the disadvantage of depleting the value of apparent winnings from a consumer's perspective and, conversely, funding from the remainder has the disadvantage of either depleting the funds available for the lottery or the game logistics. Therefore, funds reserved for second chance drawings typically are a small percentage of the purchase price (e.g., 1% to 2%) and consequently have little impact on sales.

In accordance with aspects of the invention, the second chance games can be enhanced by requiring the consumer to obtain a quorum or multiplicity of non-winning tickets that satisfy certain conditions or qualifications prior to entry of the second chance game. In this manner, the effective value reserved to each ticket in a second chance drawing (e.g., 1¢, 5¢, etc.) adds to a cumulative sum comprised of the total number of tickets required for the quorum. Thus, larger second chance prizes with better drawing odds, and consequently a higher perceived value by the consumer, is realized with enhanced second chance drawings requiring a conditional quorum of losing lottery tickets. Additionally, by purchasing insurance for relatively rare drawing events, the top second chance drawing prize(s) offered can be increased above the cumulative number of tickets.

It should be noted, that the term “quorum” in the context of this invention refers to a requirement to accumulate a multiplicity of losing tickets that satisfy specific conditions to enter a second chance drawing, and does not necessarily refer to a fixed number of tickets. For example, a quorum could be a total retail value of tickets (e.g., three $1 tickets and one $2 ticket for a $5 retail value to constitute a quorum for a second chance drawing), a total number of tickets (e.g., ten tickets), or a multiplicity of tickets to complete some form of virtual group (e.g., all of the same colored virtual properties on a Monopoly board, a group of virtual puzzle pieces to complete a picture, virtual scavenger hunt items, etc.). The significant point being that a quorum requires a consumer to accumulate a multiplicity of tickets to enter a second chance drawing, thereby enhancing the suspense and perceived value of the second chance drawing from the consumer's perspective.

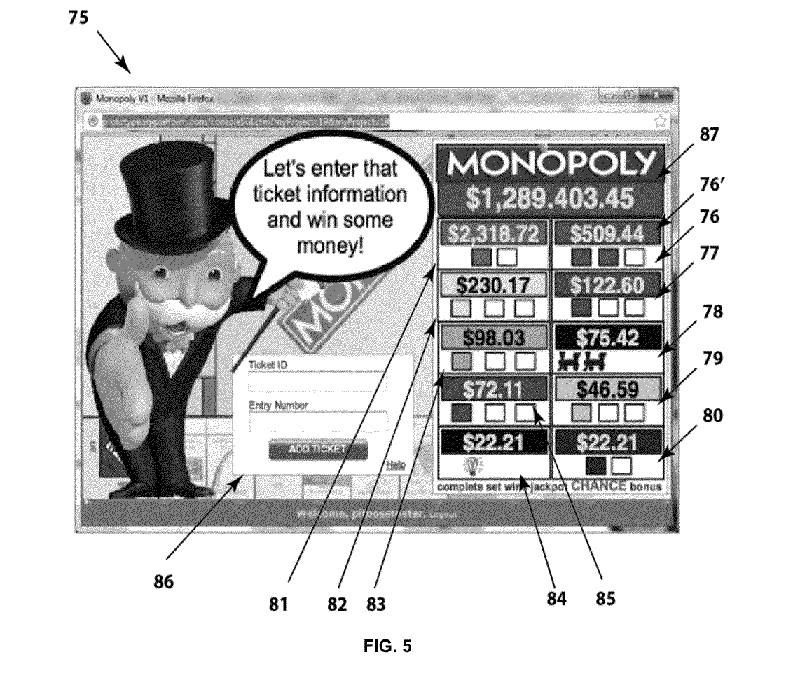

For example, FIG. 5 provides a representative example of an Internet web page 75 designed to enable a player to accumulate multiplicities of tickets for various quorums. In the example of FIG. 5, various quorums (e.g., 76-85) are available that are themed after the various properties and utilities available on a standard Monopoly game. In this example, the consumer would enter ticket information 86 from losing lottery tickets, with each ticket entered filling a required slot of a quorum. For example, in FIG. 5, two slots are filled for the quorum 76, which may constitute a particular color, such as green or red, that requires three filled slots to constitute a quorum. One slot is filled for a different color or condition for quorum 77 that also requires three filled slots to constitute a quorum. One slot is filled for railroad quorum 78 that requires four filled slots to constitute a quorum, and so forth. Once a quorum is completed, the consumer may receive an instant award and/or be entered into a drawing for a rolling jackpot 87, as explained in greater detail below.

There are multiple embodiments for filling a quorum slot. In one embodiment, each losing ticket entered could trigger a random filling of one of the available quorum slots. In another embodiment, the entered ticket may specify exactly which quorum slot would be filled (e.g., yellow quorum 82) with a ticket. If the specified quorum is already filled, the ticket entry may be used for an alternative contest, or perhaps have no value at all. In still another embodiment, the various quorums can have different values (e.g., blue quorum 81 representing Boardwalk and Park Place having a higher value than say the electric utility quorum 84), with each quorum's value tied to a separate jackpot. It should be appreciated that these examples are merely representative of the many ways quorums for a second chance drawing can be arranged.

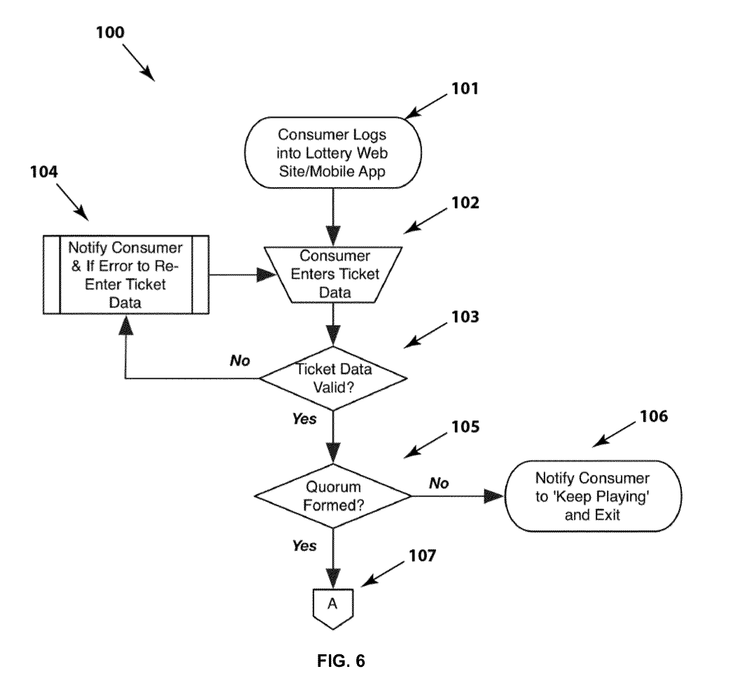

FIG. 6 illustrates a flow chart 100 of an embodiment to accumulate a quorum of non-winning tickets (e.g., tickets 25 or 50) from the consumer regardless of the specific quorum conditions. In FIG. 6, a consumer logs into a web site or mobile application 101 to enter the unique serial or validation numbers (e.g., numbers 26 or 51 from tickets 25 or 50, respectively) from their non-winning tickets 102. Of course, the referenced web site or mobile application could also be a telephone entry or mail-in system. However, in a preferred embodiment, for efficiency of information transfer, some sort of Internet communications is employed.

Returning to the flow chart of FIG. 6, once the consumer has entered the unique serial or validation numbers from their non-winning ticket(s), an algorithm 103 would validate the entered data to determine if the entered data was both authentic and not previously entered for a second chance drawing. If the entered data did not appear to be authentic to the algorithm 103, an error message 104 would be presented to the consumer informing him or her that the entered data did not appear valid. Alternatively, if the entered data appeared to be valid but already entered, the error message 104 would instead convey a ‘previously entered ticket’ message. In either case the system would return to a state to allow the consumer to either reenter or enter new ticket data 102.

Assuming valid non-winning ticket data for a ticket not previously entered, the system would then test to determine if the criteria to complete a quorum was reached for entry into a second chance drawing 105. If the criteria were met, the system would progress to entering the consumer into the second chance drawing 107. However, if an insufficient number or type of tickets had been accumulated to constitute a quorum, the consumer would be informed that the requirement has not been reached and encouraged to keep on playing at step 106. It should also be noted, that in the preferred embodiment, the system would be cognizant of the consumer's identity and therefore allow the consumer to enter non-winning tickets over multiple sessions.

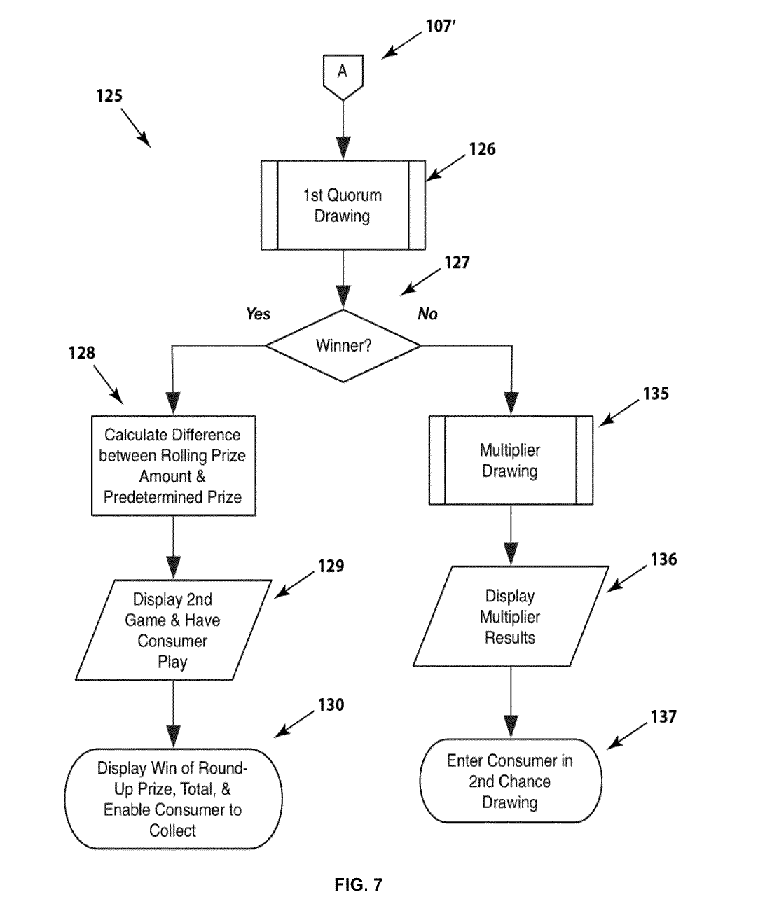

Once a quorum has been achieved at step 107/107′, separate logic 125 (FIG. 7) would then be actuated to enter the consumer in one of many possible enhanced second chance drawings. In a particular embodiment, a first second chance drawing 126 would be conducted after the quorum was achieved with the consumer immediately notified if he or she won the first drawing 127. As illustrated in FIG. 5, this first drawing could be for a rolling prize amount 76′ (e.g., $509.44 for the quorum 76) that may be continuously updated whenever the consumer references the second chance site 75. This first rolling prize amount could vary depending on the number of tickets entered, or some other condition. In a particular embodiment, the indicated prize amount 76′ may simply be a teaser that, in essence, only shows part of the actual prize value for a predetermined prize that was assigned to a specific losing ticket used to fill the quorum at the time of printing the ticket, as explained in greater detail below. It should be noted in this example that, even though a given ticket may have a predetermined prize assigned to it, the ticket would nevertheless appear to the consumer to be a non-winner in a primary lottery game, thereby creating the possibility that the consumer may never enter the ticket into a completed second chance drawing quorum. Of course, the “ticket” with a predetermined prize assigned thereto could instead be a set of multiple tickets that all must be entered into the quorum to win the quorum level prize.

Returning to the flowchart of FIG. 7, assuming the consumer has won the first drawing 126 at step 127 and the prize 76′ displayed on the associated web site 75 (FIG. 5) is a tease for a predetermined prize associated with one of the tickets entered into the quorum, then at step 128 the separate drawing logic calculates the mathematical difference between the quorum's rolling jackpot 76′ and the predetermined prize value and conducts a second game or drawing 129 (simulated or real) with the player. At step 130, the outcome of the second game or drawing is displayed as bonus prize money to the consumer that effectively adds to the quorum's rolling jackpot value to equal the predetermined prize value assigned to the quorum ticket.

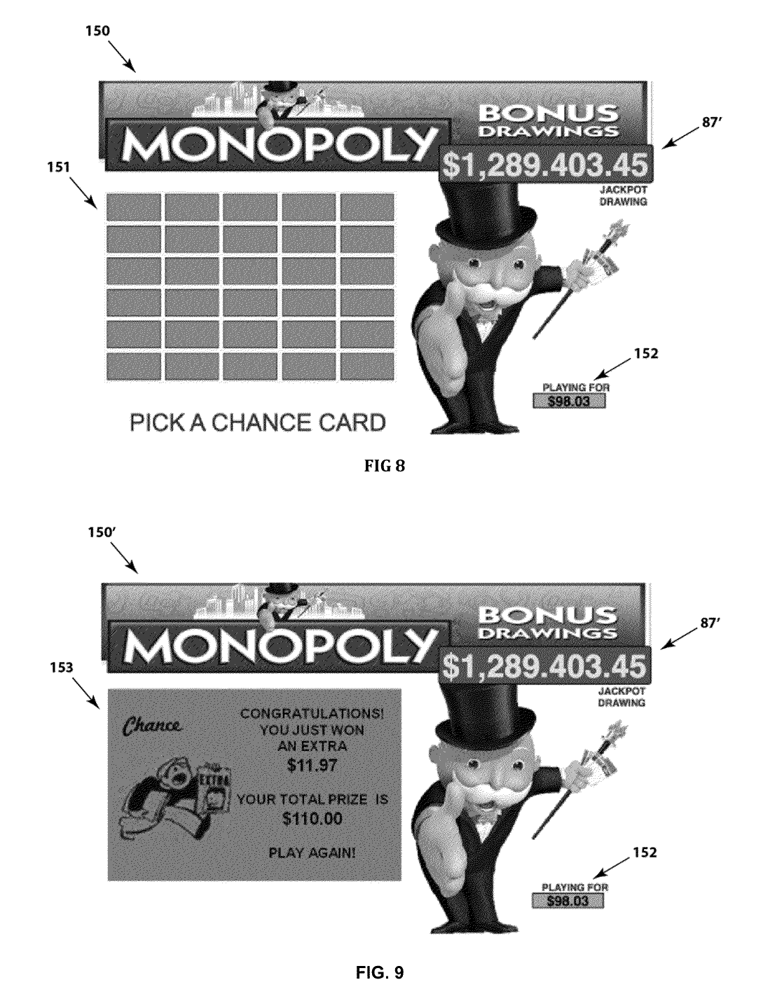

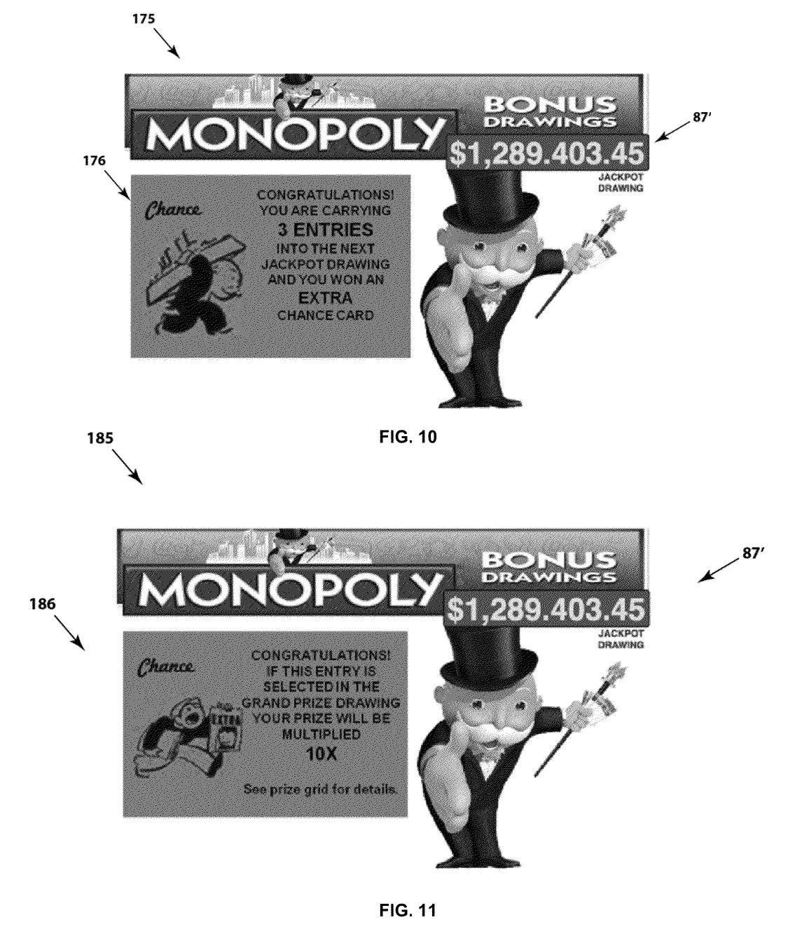

For example, FIG. 8 illustrates a second game 150 (played at step 129 in FIG. 7) designed to enable the consumer to win an additional amount over the rolling jackpot 152 for the quorum to ultimately increase the value to the predetermined quorum prize. In this particular embodiment, the consumer selects one of a multiplicity of virtual chance cards 151 (thirty virtual cards shown in FIG. 8) to play the second game. In this embodiment, no mater what virtual chance card the consumer selects, he or she will win the exact amount 153 (FIG. 9) necessary to increase the quorum jackpot 152 to the predetermined prize amount 153—i.e., $110 as shown in FIG. 9. It should be noted, that the second game prize award in this embodiment in no way impacts the grand prize rolling jackpot 87′. However, in an alternate embodiment, if the consumer did not win the second game, the difference (e.g., $11.97 as illustrated in FIG. 9) could be added to the grand prize rolling jackpot 87′.

Returning once again to the flowchart 125 of FIG. 7, in this embodiment if the consumer did not win the first drawing at step 127 after fulfilling the quorum, he or she could be awarded an entry into the grand prize rolling jackpot drawing 87′ (FIG. 8) to be held sometime in the future. In a particular embodiment, the consumer might be offered the opportunity to play another game at step 135 where he or she could win a multiplier prize 136 that would effectively multiply the grand prize rolling jackpot 87′ of FIG. 8 by whatever value 136 was won by the consumer. At the conclusion of the multiplier game, at step 137 the consumer would be entered into the grand prize rolling jackpot 87/87′ draw to be held in the future. In a particular embodiment, if the consumer would win the grand prize rolling jackpot 87/87′, the value displayed would be multiplied by any multiplier value 136 the consumer had already won. In some embodiments, it may be desirable for the gaming institution to take out a separate insurance policy wherein a portion of the prize fund is devoted to pay for the insurance policy, wherein the policy covers the possibility of a consumer with a large multiplier (e.g., ×10) also winning a large grand prize rolling jackpot 87/87′. Alternatively, the grand prize rolling jackpot 87/87′ could be algorithmically reduced such that in the event the maximum multiplier was held by the consumer that won the grand prize rolling jackpot, the total prize awarded would remain in the prize fund for the game. Of course, there are numerous other variations of how to implement the grand prize rolling jackpot 87/87′ (e.g., feedback on prizes not won, replacing a multiplier by number of entries 175—see FIG. 8 176—into the drawing, etc.) that are obvious to one skilled in the art.

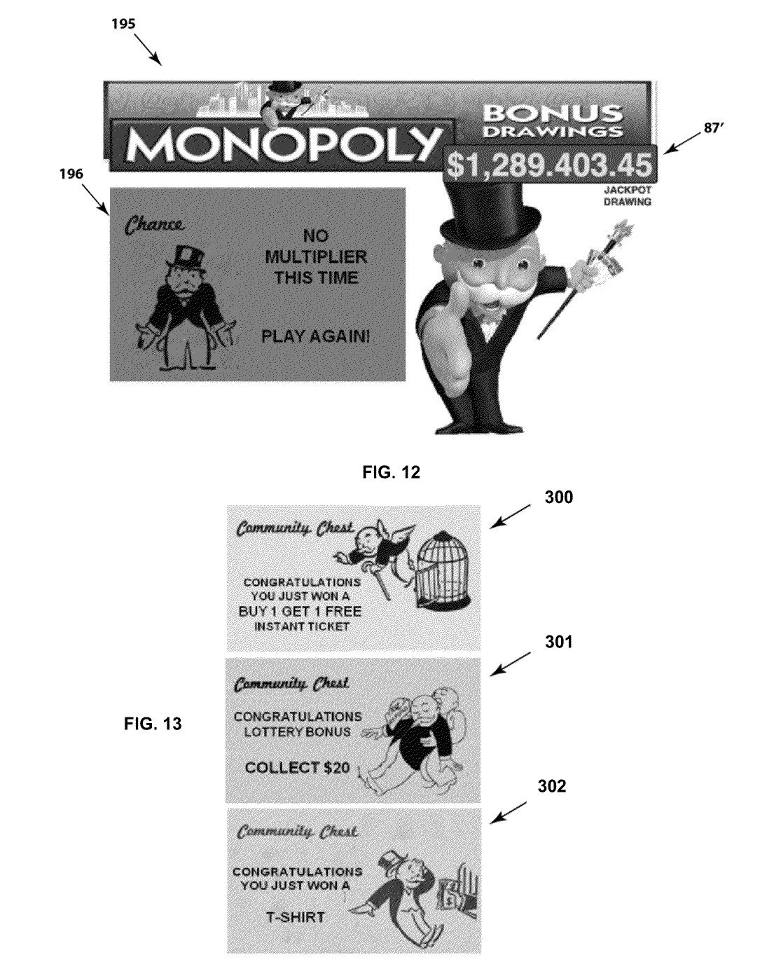

An example of a multiplier game 185 prior to an entry into the grand prize rolling jackpot 87/87′ drawing is provided in FIG. 11. As shown in FIG. 11, the outcome of a multiplier game 186 could be a value to multiply the grand prize rolling jackpot 87′ by (×10 as illustrated in FIG. 11) assuming the consumer also won the grand prize rolling jackpot 87′ second chance drawing. As previously described, there are a multiplicity of methods to accommodate the multiplier, ranging from purchasing insurance for large multiplier values (e.g., ×10 as illustrated 186 in FIG. 11) to reducing the totalizer value to accommodate the budgeted grand prize value in the event a consumer with the maximum multiplier won the grand prize rolling jackpot 87′ drawing. Additionally, as shown in FIG. 12, the multiplier awards could be rare events with the majority of consumers receiving no multiplier 196 after playing the multiplier game 195—the relatively rare multiplier prize readily accommodating insurance coverage.

Of course, the grand prize rolling jackpot 87′ could also be financed from multiple jurisdictions, thereby readily accommodating larger jackpots in much the same way the draw game Powerball relies on multiple state lotteries pooling their sales to increase the top prize value. In this embodiment, local jurisdictions may introduce their own low-tier instant prizes wherever a consumer completes a quorum, as shown in FIG. 13 by quorum prizes 300, 301, and 302. In the case of local jurisdiction low-tier prizes, funding could be accommodated by a separate prize fund, or from the funds saved from withholding entry into the grand prize rolling jackpot 87′.

Regardless of the method of funding the grand prize rolling jackpot 87′, the jackpot itself can be structured to be periodic. For example, the first of every month the grand prize rolling jackpot 87′ could be initialized with a value of say $10,000 and increases every day as sales are realized. Then at the end of each month, a drawing could be automatically conducted to determine the winner of the grand prize rolling jackpot 87′, with the jackpot value automatically resetting to the initialization amount. Alternatively, there could be a chance of no one winning the jackpot at the end of the period with the accumulated funds rolling over into the next period.

Various new and innovative methods have been disclosed concerning the problem of maintain second chance drawings as an inducement to increase sales.

What is claimed is:

1. A computer-implemented method for conducting a lottery second chance game program, the method comprising:
issuing a game ticket to a player, the game ticket for use in a primary lottery game play, the game ticket having a unique identifier thereon;
with a computer-based system, performing the following:
defining a quorum condition for entry into each of a plurality of second chance games, wherein a plurality of losing game tickets in the primary lottery game are needed to satisfy the quorum condition for each of the second chance games;
assigning a quorum value to the game tickets issued to players in the primary lottery game, the quorum value linked to the unique identifier of each game ticket;
receiving the unique identifier assigned to the respective losing game tickets from the player;
applying the quorum value for the entered losing game tickets to the quorum conditions for the second chance games;
establishing an actual prize value for each of the second chance games, wherein the actual prize value is predetermined by one of the losing game tickets used to satisfy the quorum condition for the respective second chance game;
indicating a rolling prize amount to the player that varies over time, wherein the rolling prize amount may be less than or greater than the actual prize value; and
upon satisfaction of the quorum condition for one of the second chance games, conducting an initial game event that the player must win prior to being awarded the rolling prize amount and qualifying for any difference between the rolling prize amount and the actual prize value.

2. The method as in claim 1, wherein players are immediately awarded a prize upon satisfaction of a quorum condition for one of the second chance games in addition to the predetermined prize amount.

3. The method as in claim 1, wherein the losing game tickets entered by the players are automatically and randomly assigned a quorum slot in one of the quorum conditions for the second chance games.

4. The method as in claim 1, wherein each of the losing game tickets entered by the players are assigned a predetermined quorum slot in one of the quorum conditions for the second chance games.

5. The method as in claim 4, wherein, if the predetermined quorum slot of a losing game ticket entered by a player is already filled, the losing game ticket has no value in the second chance games.

6. The method as in claim 1, wherein whether or not the player wins in the initial game event after satisfaction of the quorum condition is predetermined by the one or more losing tickets that satisfied the respective quorum condition, the initial game event being a simulated game event to reveal the predetermined outcome to the player.

7. The method as in claim 6, wherein the predetermined outcome in the simulated game event is not made known to the player until conduct of the game event, such that outcome in the simulated game event appears to the player as a random outcome.

8. The method as in claim 7, wherein the respective rolling prize amount associated with the plurality of second chance drawings are presented to the player when entering losing ticket data via a website, or accessing the website to check status of satisfying the quorum conditions.

9. The method as in claim 7, wherein the actual prize value is not made known to the player, such that the player believes that the prize for the simulated game event is the rolling prize amount.

10. The method as in claim 9, wherein the player is awarded the rolling prize amount in the simulated game event if the actual prize amount is equal to or less than the rolling prize amount.

11. The method as in claim 9, wherein the actual prize value is greater than the rolling prize amount and a difference is calculated between the actual prize value and the rolling prize amount, and the player is required to play and win a second game event in order to receive the difference amount.

12. The method as in claim 11, wherein it is predetermined that the player will receive the entire amount of the actual prize value, and the second game event is a simulated game to reveal and award the difference amount to the player.

13. The method as in claim 11, wherein the player is not guaranteed to win the difference amount, the second game event being an actual random game event that the player must win in order to be awarded the difference amount.

14. The method as in claim 1, further comprising establishing a second chance grand jackpot game event that is conducted separately from the plurality of second chance games, wherein players that are not winners in the initial game event after satisfaction of the quorum condition are automatically entered into the grand jackpot game event.

15. The method as in claim 14, wherein the grand jackpot game event is a drawing event that is conducted periodically.

16. The method as in claim 15, wherein entrants in the grand jackpot event are also entered into a multiplier drawing that is conducted prior to the grand jackpot drawing event, wherein players may be awarded a multiplier to be applied to the grand jackpot award.
